(19) United States
(12) Patent Application Publication
(10) Pub. No.: US 2010/0243005 A1
(43) Pub. Date: Sep. 30, 2010

(54) WATER-CARRYING HOUSEHOLD APPLIANCE

(75) Inventors: Johannes Büsing, Emersacker (DE); Peter Geissler, Holzheim (DE); Cengiz Kücük, Syrgenstein (DE); Manfred Seessle, Gerstetten (DE); Hermann Stempfle, Glott (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/743,379

(22) PCT Filed: Oct. 29, 2008
(86) PCT No.: PCT/EP2008/064633

§ 371 Date: May 18, 2010

(30) Foreign Application Priority Data
Nov. 29, 2007 (DE) 10 2007 057 515.9

(51) Int. Cl. B08B 3/00; B23P 17/04

(52) U.S. Cl. 134/105; 29/428

(57) ABSTRACT

A water-carrying household appliance, in particular a dish-rinsing or dish-washing machine, with at least one water-carrying line whose line end is connected to a connection pipe of a heat exchanger or water inlet. In an exemplary embodiment of the invention, the household appliance may include a holder which pre-positions the line end of the water-carrying line into a connection position for the connection to the connection pipe. The invention also discloses a method for assembling the water-carrying household appliance.

The invention relates to a water-carrying household appliance as claimed in the preamble of claim 1.

In water-carrying household appliances, for instance dishwashing machines, appliance units, such as a water chamber serving as a heat exchanger, discharge pump or washing chamber, are connected to one another by way of water-carrying lines. The heat exchanger and/or water inlet of a dishwashing machine has a connection pipe for a discharge hose coming from the discharge pump and a connection pipe for a discharge hose leading to the water supply network. The water-carrying lines can each be moved onto connection pipes of the appliance unit and secured with an additional securing part, a securing nut for instance.

For connection to the heat exchanger and/or water inlet of the dishwashing machine, each discharge hose is individually moved by hand onto the assigned connection pipe of the heat exchanger/water inlet and secured there, thereby producing significant assembly costs.

DE 1 460 825 discloses a connecting plate in particular for use in washing machines, which, on its front side, has a connection for a water line and on its rear side has a open-top chamber, the base of which has a pipe connection for connecting a water-carrying line.

The object of the invention consists in providing a water-carrying household appliance, in particular a dishwashing machine, and a method for assembling such a household appliance, in which the assembly costs are reduced.

The object is achieved by the features of claim 1 or 14. Advantageous developments of the invention result from the subclaims.

According to the characterizing portion of claim 1, the household appliance has a holder which is independent of the water inlet and/or water exchanger for the line end of the at least one water-carrying line. The holder positions the line end in the connection position for simple connection to the connection pipe of the heat exchanger/heat inlet.

To further simplify assembly, in a preassembly state when the heat exchanger/water inlet is still separate from the household appliance, the holder can correctly pre-position the line end of the water-carrying line in the connection position, in which the line end preferably protrudes vertically upward. The holder enables the line end to be accurately positioned on the device side and to be adequately fastened. During the assembly of the heat exchanger/water inlet in the household appliance, its connection pipe can be automatically inserted into the pre-positioned line end and is secured therein without an additional securing part. The already pre-positioned line end produces a simplified water connection of the water inlet and/or heat exchanger.

The holder is preferably provided on an assembly base of the household appliance. In terms of manufacturing, it is preferred if the assembly base and the holder are embodied with the same material and/or in one piece. In the event that the assembly base is manufactured from plastic, the holder can therefore be injection molded to the assembly base.

For a technically simple realization of the holder, this can comprise two holding arms, between which the line end of the water-carrying line can be inserted in order to hold the line end in its connecting position.

By means of the afore-cited holding arm, the line end is fixed at least in a depth direction and/or in side directions of the household appliance. Furthermore, the holder can be provided with a height stop, which also correctly pre-positions the line end in the height direction. In a simple embodiment, the height stop can be embodied by lateral recesses, in particular by an annular groove, in the line end of the water-carrying line. The holding arms of the holder protrude here into the annular groove of the line end and hold the line end therebetween, as a result of which the line end is also accurately pre-positioned in the height direction.

The water-carrying line is usually a hose line, which does not have its own and/or only has minor form stability and can therefore be easily positioned in the household appliance as a function of the installation space.

The holder can comprise a holding plate with one groove-type open recess with an insertion opening. The recess is delimited by the two holding arms and a transverse limb connecting the two holding arms. The transverse limb is used in turn as a side stop for the accurate pre-positioning of the line end.

For assembly reasons, an almost automatic coupling of the pre-positioned line end with the connection pipe of the heat exchanger/water inlet is preferable during the assembly of the heat exchanger/water inlet. To this end, the line end of the water-carrying line can be aligned with its open connection side counter to an assembly direction of the heat exchanger, i.e. protrude in particular vertically upward.

To assist with the correct pre-positioning of the line end in the holder, the holder, in particular on its side facing away from the heat exchanger/water inlet, can also include additional lateral guide walls. The line carried to the holder can already be roughly aligned between these guide walls in the direction of the heat exchanger.

The holder can preferably pre-position at least two water-carrying lines. To reduce the installation space needed herefore, the holder can comprise a shared first holding arm, which is arranged between two opposite second holding arms. The middle first holding arm can herewith pre-position the line ends of the water-carrying lines in a space-saving fashion using the two lateral holding arms.

The groove-like open recesses which are delimited by the holding arms can be aligned here counter to one another in order to embody the holding plate in an overall geometrically inherently form-stable and/or warp-resistant manner.

In a method for assembling the water-carrying household appliance, in a preassembly step, the line end can be pre-positioned in a positionally correct connection position when the heat exchanger/water inlet is still separate from the household appliance. In a following installation step, the heat exchanger/water inlet can then be integrated into the household appliance and assembled. At the same time as installing the heat exchanger into the household appliance, its connection pipe can in this way be connected to the pre-positioned line end.

An exemplary embodiment of the invention is shown below on the basis of the appended Figures, in which;

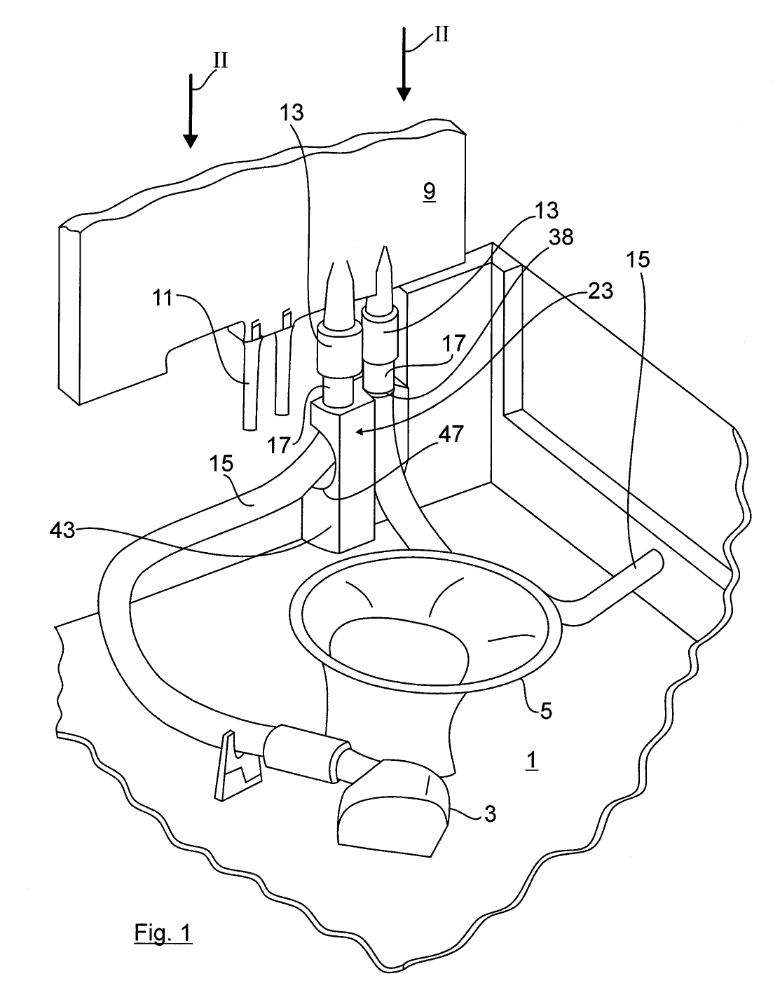

FIG. 1 shows a perspective partial view of an assembly base of a dishwashing machine with a heat exchanger;

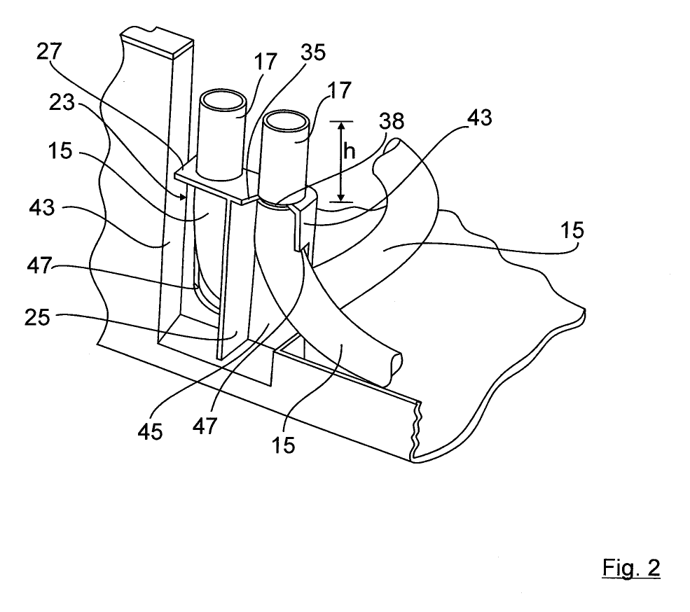

FIG. 2 shows an enlarged perspective partial view of the hose ends of discharge tubes to be connected to the heat exchanger which are pre-positioned in a connection position; and

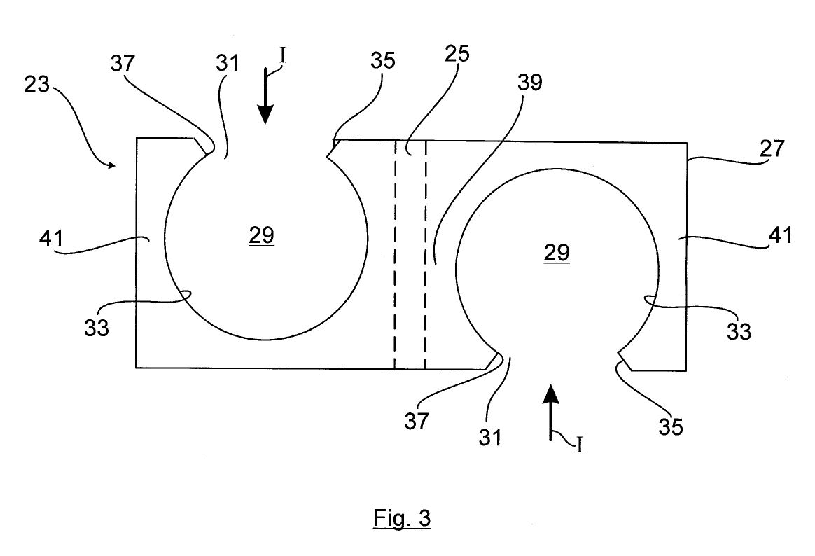

FIG. 3 shows a view from above of a holding plate for pre-positioning the hose ends.

FIG. 1 shows an enlarged perspective partial view of an assembly base 1 of a dishwashing machine in a preassembly state. The assembly base 1 of the dishwashing machine is manufactured as a plastic-injection molded part. According to FIG. 1, a discharge pump 3 is mounted on the assembly base 1 with an assigned pump sump 5. A heat exchanger 9 is also shown, which is mounted on a washing chamber (not shown).

The heat exchanger 9 has supports 11, to which hose lines (not shown) are connected. Furthermore, the platform-like heat exchanger 9 has two vertical downwardly protruding connection pipes 13, which are connected via hose lines 15 to the pressure side of the discharge pump 3 and to the water supply network in each instance.

Here the hose lines 15 essentially have no instrinsic form stability, so that they can be easily positioned within the dishwashing machine as a function of the available installation space. Each of the two hose lines 15 has an open tube-end piece 17 on its end facing the heat exchanger 9, in which a connection pipe 13 of the heat exchanger 9 is inserted. The hose end pieces 17 of the two hose lines protrude vertically upwards.

The hose end pieces 17 of the hose lines 15 are pre-positioned in a connection position on a holder 23 injection molded to the assembly base 1, as is shown in FIG. 2. The holder 23 is embodied according to FIG. 2 in a T-shape with a vertical middle wall 25 and a horizontal holding plate 27 molded thereto.

As apparent from FIG. 3, two adjacent open recesses 29 aligned counter to one another are embodied in the holding plate 27. The hose end pieces 17 can each be inserted laterally into recesses 29 in an insertion direction I, as indicated in FIG. 3. Each of the two recesses 29 to this end has a narrow insertion opening 31 with a circular extended holding section 33. The narrow insertion opening 31 is delimited by insertion bevels 35.

At the change-over between the insertion bevels 35 and the circularly extended holding section 33, each of the recesses 29 has locking edges 37. These secure the hose end piece 17 inserted into the recess 29 in a form-fit fashion against unintentional removal. The hose end pieces 17 are thus fixedly held in their radial direction, i.e. in the plane of projection in FIG. 3, in the holding plate 27.

Furthermore, the hose end pieces 17 for a positioning which is fixed in the axial direction and/or vertical direction have an annular groove 38, which surrounds the peripheral edge of the respective recess 29 of the holding plate 27 in a form-fit fashion. As a result, hose end pieces 17 inserted into the recesses 29 of the holder 23 protrude vertically upwards by a predetermined height h beyond the holding plate 27 (FIG. 2).

As apparent from FIG. 3, the two recesses 29 in the holding plate 27 are delimited by a shared, middle, first holding arm 39 and by opposing second holding arms 41.

The holder 23 is arranged according to FIG. 2 in a wall region which recoils relative to an outer assembly base side wall. The side walls 43 and the rear wall 45 of the recoiling wall region, together with the middle wall 25, each form insertion shafts. The hose lines 15 are, in accordance with FIG. 2, already roughly pre-positioned in the direction of the heat exchanger, so that a positionally-correct, secure fitting of the end pieces 17 is ensured in the holder 23. The two hose lines 15 are guided into the side walls 43 by openings 47 and into the respective insertion shafts in the rear wall 45 of the recoiling wall region.

During assembly of the dishwashing machine, in a preassembly step, the two hose end pieces 17 of the hose lines 15 are initially correctly pre-positioned in their connection position on the holder 23, namely when the heat exchanger 9 is still separate from the dishwashing machine. The heat exchanger 9 in the assembly device II shown in FIG. 1 is then mounted on the washing chamber. During assembly on the washing chamber, the connection pipes 13 of the heat exchanger 9 are automatically inserted into the pre-positioned hose end piece 17, without additional securing sleeves and/or nuts being needed for a reliable coupling.

1-15. (canceled)

16. A water-carrying household appliance, comprising:
at least one water-carrying line, a line end of which is connected to a connection pipe of one of a water chamber and a water inlet used as a heat exchanger; and
a holder structured to position the line end of the water-carrying line in a connection position for connection to the connection pipe.

17. The water-carrying household appliance as claimed in claim 16, wherein in the connection position, when the one of a water chamber and a water inlet is separate from the household appliance, the holder is structured to position the line end in the connection position.

18. The water-carrying household appliance as claimed in claim 16, wherein the holder is arranged on an assembly base of the household appliance and is one of a same material as the assembly base and in one piece as the assembly base.

19. The water-carrying household appliance as claimed in claim 18, wherein the holder is plastic.

20. The water-carrying household appliance as claimed in claim 16, wherein the holder includes two holding arms, between which the line end of the water-carrying line is inserted.

21. The water-carrying household appliance as claimed in claim 20, wherein the line end of the water-carrying line includes at least one positioning stop having an annular groove which engages with the holder for a height positioning of the line end.

22. The water-carrying household appliance as claimed in claim 20, wherein the holder includes an open recess delimited by the two holding arms with an insertion opening.

23. The water-carrying household appliance as claimed in claim 22, wherein the recess includes locking projections on an insertion opening of the recess, which hold the line end in the recess.

24. The water-carrying household appliance as claim 16, wherein the line end of the water-carrying line is aligned on an open connection side counter to an assembly direction of the one of a water chamber and a water inlet and protrudes vertically upwards.

25. The water-carrying household appliance as claimed in claim 16, wherein the holder on a side of the holder facing away from the connection pipe, includes lateral guide walls, which are operable to position the water-carrying line.

26. The water-carrying household appliance as claimed in claim 16, wherein the holder is structured to hold at least two water-carrying lines.

27. The water-carrying household appliance as claimed in claim 26, wherein the holder includes a shared first holding arm, which, with two opposite second holding arms, positions respective line ends of the two water-carrying lines.

28. The water-carrying household appliance as claimed in claim 27, wherein open recesses delimited by the holding arms are aligned counter to one another.

29. A method for assembling a water-carrying household appliance in which a water chamber used as one of a heat exchanger and a water inlet is integrated in the household appliance, the method comprising:
connecting a line end of a water-carrying line to a connection pipe of the one of a heat exchanger and a water inlet wherein, in a preassembly step, the line end is pre-positioned in a positionally-correct connection position in respect of a position of the connection pipe and in a subsequent installation step, when integrating the one of a heat exchanger and a water inlet into the household appliance, the connection pipe is automatically connected to the pre-positioned line end.

30. The method as claimed in claim 29, wherein in the preassembly step, the line end is pre-positioned when the one of a heat exchanger and a water inlet is separate from the household appliance.
